(19) United States
(12) Patent Application Publication
(10) Pub. No.: US 2025/0107956 A1
(43) Pub. Date: Apr. 3, 2025

(54) MASSAGE MACHINE

(71) Applicant: SAMSUNG ELECTRONICS CO., LTD., Suwon-si (KR)

(72) Inventors: Takuro SAKAMAKI, Osaka (JP); Yusuke NAKANISHI, Osaka (JP); Manabu KIKUCHI, Osaka (JP); Makoto SHIBUYA, Osaka (JP); Minoru TEMMYO, Osaka (JP); Shigenori HATO, Osaka (JP)

(21) Appl. No.: 18/823,692

(22) Filed: Sep. 4, 2024

Related U.S. Application Data
(63) Continuation of application No. PCT/KR2024/009847, filed on Jul. 10, 2024.

(30) Foreign Application Priority Data
Sep. 29, 2023 (JP) 2023-170036

(51) Int. Cl. A61H 15/02; A61H 15/00

(52) U.S. Cl. CPC A61H 15/02; A61H 2015/005; A61H 2201/0149; A61H 2201/0207; A61H 2201/1611; A61H 2201/1623; A61H 2201/1671; A61H 2201/1676; A61H 2203/0431; A61H 2205/04

(57) ABSTRACT

A massage machine includes a massage ball and an arm. The massage ball is fixed to the arm. The massage ball includes a surface part, a support shaft fixed to the arm, a heater that heats the surface part, a heat transfer part that transfers heat from the heater to the surface part and is disposed between the heater and the support shaft, a sliding part that supports the surface part rotatably with respect to the heat transfer part by slidingly contacting the surface part, and an elastic body that is disposed on a heat transfer path between the heat transfer part and the arm.

### CROSS-REFERENCE TO RELATED APPLICATIONS

This application is a continuation application, under 35 U.S.C. § 111 (a), of International Patent Application No. PCT/KR2024/009847, filed on Jul. 10, 2024, which claims priority to Japanese Patent Application No. 2023-170036, filed on Sep. 29, 2023, the content of which in its entirety is herein incorporated by reference.

### TECHNICAL FIELD

The disclosure relates to a massage machine.

### BACKGROUND ART

Japanese Patent Publication No. 2013-78670 discloses a massage apparatus including a treating element. The treating element includes first and second case members which are connected to an arm of the massaging apparatus, and accommodate a positive temperature coefficient (PTC) heater to transfer heat from the PTC heater to a user, and a massage ball which presses the body of the user. The first and second case members which accommodate the PTC heater are provided between the arm and the massage ball.

Japanese Patent Publication No. 2020-512876 discloses a thermotherapy device including a thermal ceramic module, a weight sensor, and a controller. The thermal ceramic module includes a body, a first support plate positioned in an upper portion of the body, a second support plate positioned in an upper portion of the first support plate, an elevation driving unit coupled to a lower portion of the first support plate to move the first support plate in an up and down direction with respect to the body, and a ceramic member coupled to the second support plate. The weight sensor is provided on a lower surface of the second support plate to sense a body pressure of a user. The controller controls setting and execution of a massage mode of the thermal ceramic module. The controller controls a driving height of the elevation driving unit according to the body pressure of the user sensed by the weight sensor such that the same pressure is provided to the user by the ceramic member, based on a preset target strength.

### SUMMARY

A massage machine includes a massage ball and an arm. The massage ball is fixed to the arm. The massage ball includes a surface part, and a support shaft fixed to the arm. The heater heats the surface part. A heat transfer part that transfers heat from the heater to the surface part is disposed between the heater and the support shaft. A sliding part supports the surface part rotatably with respect to the heat transfer part by slidingly contacting the surface part. An elastic body is disposed on a heat transfer path between the heat transfer part and the arm.

### DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a schematic perspective view of an embodiment of the exterior of a massage machine according to the disclosure.

FIG. 2 is a perspective view of an embodiment of a massage ball according to the disclosure.

FIG. 3 is a cross-sectional perspective view of a massage ball, taken along line III-III of FIG. 2.

FIG. 4 is an exploded perspective view of an embodiment of a massage ball according to the disclosure.

FIG. 5 is a view for explaining an embodiment of a first operation of an elastic body applied to a massage ball, according to the disclosure.

FIG. 6 is a view for explaining an embodiment of a first operation of an elastic body applied to a massage ball, according to the disclosure.

FIG. 7 is a view for explaining an embodiment of a second operation of an elastic body applied to a massage ball, according to the disclosure.

FIG. 8 is a schematic cross-sectional view of an embodiment of a massage ball according to the disclosure.

FIG. 9 is a schematic cross-sectional view of an embodiment of a massage ball according to the disclosure.

FIG. 10 is a schematic cross-sectional view of an embodiment of a massage ball according to the disclosure.

FIG. 11 is a schematic cross-sectional view of an embodiment of a massage ball according to the disclosure.

FIG. 12 is a cross-sectional view of an embodiment of a massage ball according to the disclosure.

FIG. 13 is a cross-sectional view of an embodiment of a massage ball according to the disclosure.

FIG. 14 is a schematic perspective view of an embodiment of the exterior of a massage machine according to the disclosure.

FIG. 15 is a schematic plan view of an embodiment of a massage ball applied to the massage machine shown in FIG. 14.

### MODE FOR INVENTION

It should be understood that various embodiments of the disclosure in this document and terms used therein are not intended to limit the technical features described herein to particular embodiments of the disclosure and that the disclosure includes various modifications, equivalents, or substitutions of the embodiments of the disclosure.

With regard to the description of the drawings, like reference numerals may be used to represent like or related elements.

A singular form of a noun corresponding to an item may include one or a plurality of the items unless the context clearly indicates otherwise.

As used herein, each of the phrases such as “A or B,” “at least one of A and B, “at least one of A or B,” “A, B, or C,” “at least one of A, B, and C,” and “at least one of A, B, or C” may include any one of the items listed together in a corresponding one of the phrases, or all possible combinations thereof.

The term “and/or” includes any combination of a plurality of associated elements listed, or any one of the plurality of associated listed elements.

Terms such as “first,” “second,” etc., may be used simply to distinguish an element from other elements and do not limit the elements in any other respect (e.g., importance or order).

It will be understood that when an element (e.g., a first element) is referred to, with or without the term “functionally” or “communicatively”, as being “coupled” or “connected” to another element (e.g., a second element), the element may be coupled to the other element directly (e.g., in a wired manner), wirelessly, or via a third element.

The terms such as “comprise,” “include,” or “have” are intended to specify the presence of stated features, numbers, steps, operations, elements, components, or combinations thereof, but do not preclude the presence or addition of one or more other features, numbers, steps, operations, elements, components, or combinations thereof.

It will also be understood that when an element is referred to as being “connected,” “coupled,” “supported,” or “in contact” with another element, this includes not only when the elements are directly connected, coupled, supported, or in contact, but also when they are indirectly connected, coupled, supported, or in contact via a third element.

It will also be understood that when an element is referred to as being “on” another element, the element may be directly on the other element, or intervening elements may also be present therebetween.

In a massage ball of a conventional home massaging apparatus, a portion close to a heat source is made of a metal material with relatively high thermal conductivity, and most of a portion that touches the human body is made of an elastic material, such as rubber, with relatively low thermal conductivity. Therefore, uneven temperature may occur on the surface of the massage ball that touches the human body, making it difficult to achieve a sufficient effect in procedures for activating parasympathetic nerves, because the massage ball focuses on lowering a surface pressure to avoid pain during a treatment and reproducing masseuse's hand movements, rather than a heating function.

In the case of the massage ball of a medical massage bed, a heat source is placed on a support shaft of the massage ball made of a hard material such as ceramic, and a spring is placed between the massage ball and the support plate to adjust a pressure applied to the human body. With this structure, a surface portion of the massage ball that touches the human body is entirely made of the same material and has relatively high thermal conductivity, so temperature unevenness is unlikely to occur. However, when a motion of the massage ball with respect to the support plate is regulated using a rotation axis, a force acting in a direction tangential to the rotation trajectory of the massage ball may be cushioned by the spring, but forces acting in the other directions is unable to be cushioned by the spring. In addition, a space for installing the spring and a space for installing a mechanism that regulates the movement of the massage ball are desired, which may result in an increase in the size of massage apparatuses. Moreover, the support shaft and the support plate are generally made of metal to ensure strength, but heat from the heat source is transmitted not only to the surface of the massage ball but also to the support shaft and the support plate, leading to a reduction in energy efficiency. In order to suppress such unnecessary heat transfer, a method of placing an insulation member in an area where heat transfer is to be suppressed may be considered. However, this method may result in a decrease in the strength of a member to which the insulation member is added, and an increase in the size of massage apparatuses due to an increase in the number of component parts due to the addition of the insulation member.

The disclosure provides a massage machine capable of heating a surface part of a massage ball to a uniform temperature. The disclosure provides a massage machine capable of adjusting the pressure when a massage ball touches a human body. However, the technical problems to be achieved in this document are not limited to the above-mentioned technical problems, and other technical problems not mentioned will be clearly understood by a person skilled in the art to which the disclosure pertains from the following description.

The massage ball may include a surface part, a heat transfer part including a heater, a support shaft, and a sliding part rotatably supporting the surface part with respect to the heat transfer part. The surface part and the heat transfer part include or consist of a material with relatively high thermal conductivity. An elastic body is disposed between the heat transfer part and the support shaft. Accordingly, the surface part of the massage ball may be heated to a uniform temperature, and the pressure when the massage ball touches the human body may be adjusted regardless of the direction of the pressure acting on the human body. In addition, because a separate member for pressure adjustment needs to be placed outside the massage ball, and the heat transfer part and the support shaft are thermally insulated from each other by the elastic body, space saving and energy saving are possible, and a massage device with fewer component parts may be realized. The elastic body may be disposed between the support shaft and the arm. As a result, transfer of heat energy from the heater to the arm is suppressed, so that more heat energy may be transmitted to the human body through the surface part.

Hereinafter, massage machines in embodiments of the disclosure will be described more fully with reference to the accompanying drawings.

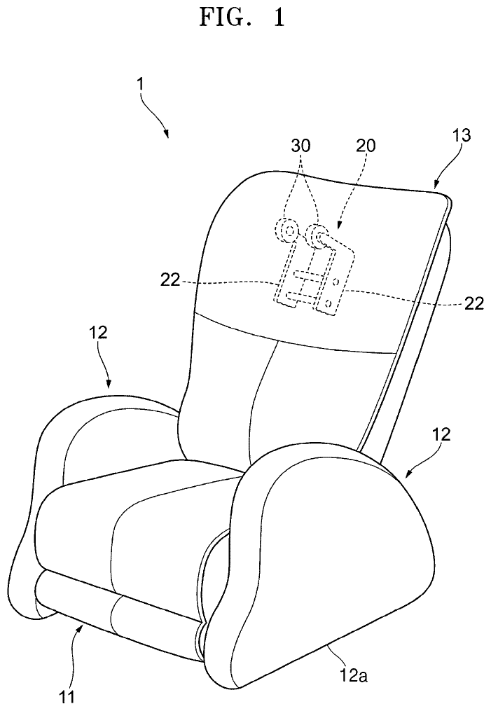

FIG. 1 is a schematic perspective view of an embodiment of the exterior of a massage machine 1 according to the disclosure. Referring to FIG. 1, the massage machine 1 may include a seat part 11, a pair of support frames 12 supporting the seat part 11, and a backrest 13 supported by the pair of support frames 12 and disposed on the rear side of the seat part 11 to support the back of a person to be treated. The massage machine 1 includes a massage mechanism 20 capable of massaging an affected area of the person to be treated. In the following description, a front-rear direction, a left-right direction (width direction), and an up-down direction are directions seen from the perspective of the person to be treated when the person sits on the seat part 11. The ‘back’ is a general term for the back and neck of the person to be treated.

The seat part 11 is a planar member, namely, a substantially quadrangular member, e.g., a substantially rectangular member, on which a person undergoing treatment with the massage machine 1 may sit. The seat part 11 may include a frame and a cushion material covering the frame, for example, and may be formed so that the person to be treated may sit comfortably.

The support frame 12 may include or consist of a metal plate, resin, or the like. The support frame 12 may be formed so that, when the massage machine 1 is installed on a floor, e.g., a flat floor, a lower end 12a of the support frame 12 is substantially horizontal with respect to the floor. Front and rear legs (not shown) supported on the floor may be installed on front and rear portions of the lower end 12a of the support frame 12. Support pieces may be provided at positions having substantially the same height as each other, on the pair of support frames 12. The frame of the seat part 11 may be fixed to the support pieces. Accordingly, the seat part 11 may be supported by the pair of support frames 12. Accordingly, when the massage machine 1 is installed on the flat floor, an upper surface of the seat part 11 may be approximately horizontal with respect to the floor, and the seat part 11 may be spaced upward apart from the floor.

The pair of support frames 12 may each extend further upward than the upper surface of the seat part 11. Respective upper ends of the pair of support frames 12 each extending further upward than the upper surface of the seat part 11 may be gently bent to function as armrests. Accordingly, the pair of support frames 12 are armrest frames capable of supporting the seat part 11 and functioning as armrests, and the entirety of the support frame 12 is covered with a cushion material or the like.

The backrest 13 is a substantially quadrangular member, e.g., a substantially rectangular member, when viewed from a front side of the massage machine 1 on which the person to be treated may lean. The backrest 13 supports the back of the person to be treated. The backrest 13 may include a frame and a cushion material covering the frame, similar to the seat part 11, for example, and may be formed so that the person to be treated may comfortably lean on the backrest 13. The massage mechanism 20 is provided inside the backrest 13 to massage the back of the person to be treated. The massage mechanism 20 may swing a pair of left and right massage balls 30 in the front-rear direction and in the left-right direction. The massage mechanism 20 may move a pair of left and right arms 22 for operating the pair of left and right massage balls 30, in the left-right direction.

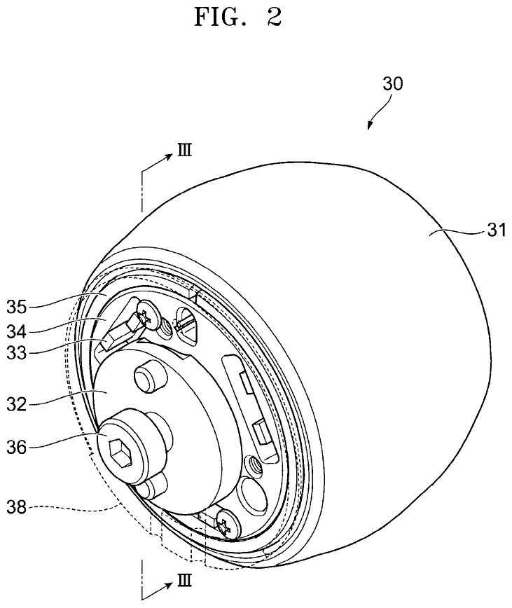

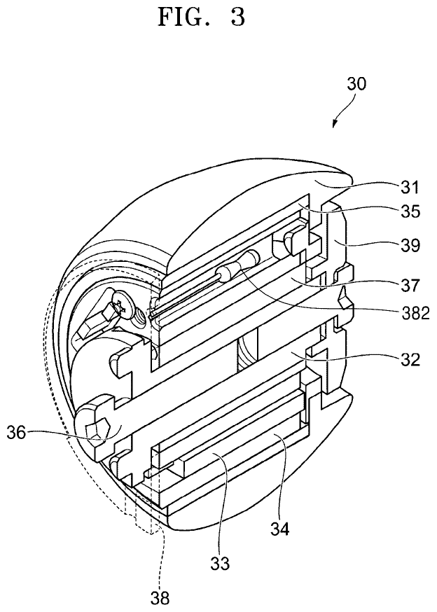

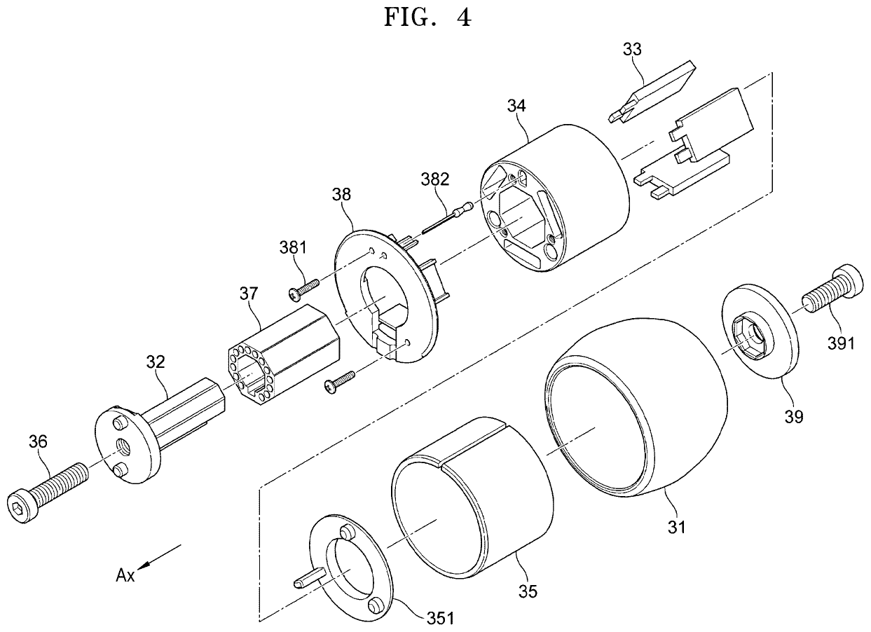

FIG. 2 is a perspective view of an embodiment of a massage ball 30 according to the disclosure. FIG. 3 is a cross-sectional perspective view of a massage ball (30), taken along line III-III of FIG. 2. FIG. 4 is an exploded perspective view of an embodiment of the massage ball 30 according to the disclosure. Referring to FIGS. 2 through 4, the massage ball 30 may include a surface part 31, a support shaft 32, a heater 33, a heat transfer part 34, and a sliding part 35. The massage ball 30 may further include an elastic body 37. The massage ball 30 may further include a fastening screw 36, a first end guide part 38, a second end guide part 39, and a fastening screw 391. The massage ball 30 may further include an end sliding part 351 and a thermistor 382.

The surface part 31 is a member that forms the surface of the massage ball 30. The surface part 31 may include or consist of a material with relatively high thermal conductivity. As a result, the entirety of the surface part 31 may be heated with a uniform temperature. The material with relatively high thermal conductivity may be, e.g., aluminum or ceramic (Al₂O₃). As will be described later, heat is transferred to the entirety of the surface part 31 by disposing the heater 33 inside the massage ball 30.

The support shaft 32 is a shaft member that is fixed to an arm 22 and supports the massage ball 30. The support shaft 32 may include or consist of, e.g., stainless steel, such as JIS SUS303.

The heater 33 is a heat generating member that generates heat by receiving electric power. The heater 33 may be, e.g., a non-flexible quadrangular, e.g., rectangular, or cylindrical positive temperature coefficient (PTC) heater. The heater 33 may be disposed in (e.g., built into) the heat transfer part 34 while in a non-curved state. That is, the heater 33 which does not include a curved portion may be disposed in the heat transfer part 34, for example.

The heat transfer part 34 is disposed between the surface part 31 and the support shaft 32. The heat transfer part 34 may include the heater 33 built therein. In other words, the heater 33 may be disposed inside the heat transfer part 34. The heat transfer part 34 transfers the heat of the heater 33 to the surface part 31. Inside the heat transfer part 34, a spacer (not shown) may be disposed to press the heater 33 toward an outer circumferential surface of the heat transfer part 34. The heat transfer part 34 may include or consist of, e.g., an aluminum alloy such as JIS A5052.

The sliding part 35 is a member for allowing the surface part 31 to rotate relative to the heat transfer part 34. In an embodiment of the disclosure, the sliding part 35 may be in sliding contact with the surface part 31. In an embodiment, the sliding part 35 may be installed in the entirety of the area between the surface part 31 and the heat transfer part 34, e.g., over the entirety of the outer circumference of the heat transfer part 34, for example. However, the disclosure is not limited thereto, and a slit may be defined in the sliding part 35 so that a substantially small area between the surface part 31 and the heat transfer part 34 is not covered by the sliding part 35. The sliding part 35 may be implemented by a metal bush with relatively high thermal conductivity, for example.

The end sliding part 351 is in sliding contact with the surface part 31 in an axial direction, thereby suppressing wearing of the heat transfer part 34 and the surface part 31. The massage ball 30 may be fastened to the arm 22 by a fastening screw 36.

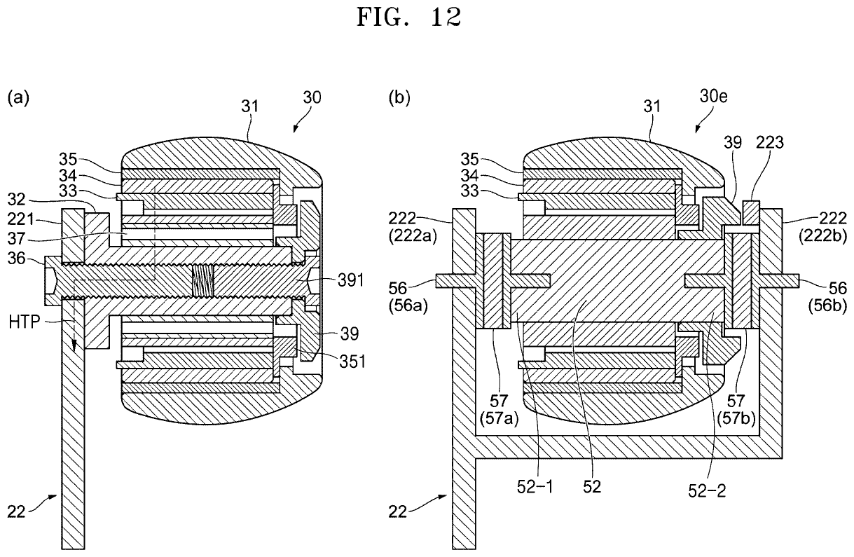

The elastic body 37 is disposed between the heat transfer part 34 and the support shaft 32. The elastic body 37 is a member that allows adjustment of the pressure with which the massage ball 30 touches the human body. In other words, the elastic body 37 adjusts the pressure so as not to cause discomfort when the hard surface part 31 of the massage ball 30 touches a bone, etc. In an embodiment, the elastic body 37 may be disposed over the entirety of the outer circumferential area of the support shaft 32 from one end of the support shaft 32 to an opposite end thereof, for example. The elastic body 37 may include or consist of an elastically deformable material, e.g., a rubber-elastic material such as silicon rubber or elastomer. Hardness of the elastic body 37 may be, e.g., 35 degrees to 50 degrees based on shore A. The elastic body 37 is disposed in a heat transfer path (e.g., HTP in FIG. 12) ranging from the heat transfer part 34 to the arm 22 via the support shaft 32. In the illustrated embodiment of the disclosure, the elastic body 37 may thermally insulate the heat transfer part 34 and the support shaft 32. Accordingly, heat from the heater 33 may be transferred to the surface part 31 efficiently with less energy.

The first end guide part 38 and the second end guide part 39 are installed on opposite ends of the support shaft 32 to restrain the surface part 31 and the heat transfer part 34 in the axial direction (e.g., Ax in FIG. 4) of the support shaft 32. By the first end guide part 38 and the second end guide part 39, a buffering direction of the elastic body 37 may be regulated only in a radial direction of the massage ball 30, and deterioration of the pressure on the human body and contact between component parts due to tilting of the surface part 31 may be suppressed. In FIGS. 2 and 3, the first end guide part 38 is depicted with a broken line so that the heater 33, the heat transfer part 34, and the sliding part 35 are visible. In an embodiment, the first end guide part 38 may be fastened to the heat transfer part 34 by a fastening screw 381, for example. The second end guide part 39 may be fastened to the support shaft 32 by the fastening screw 391.

The thermistor 382 detects an internal temperature of the heat transfer part 34 to adjust the temperature of the surface part 31 to a predetermined temperature range.

As shown in FIGS. 2 through 4, in the massage ball 30 according to the disclosure, the surface part 31, the heater 33, the heat transfer part 34, the sliding part 35, and the elastic body 37 are disposed concentrically with a support axis (e.g., the axial direction Ax in FIG. 4) of the support shaft 32 as its center. Due to this structure, a fastening member that fixes the massage ball 30 in the radial direction and a tangential direction is unnecessary, so that the number of component parts may be reduced.

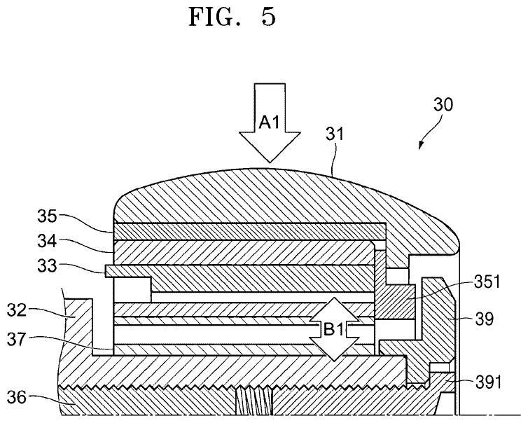

FIG. 5 is a view for explaining an embodiment of a first operation of the elastic body 37 applied to the massage ball 30, according to the disclosure. FIG. 5 shows an upper half of the cross-sectional view of FIG. 3. Referring to FIG. 5, during a treatment, pressure may be applied to the massage ball 30 as indicated by arrow A1. Then, the elastic body 37 may be elastically deformed as indicated by arrow B1 to buffer the pressure. In the illustrated embodiment of the disclosure, the elastic body 37 is disposed over the entirety of the circumference of the massage ball 30, that is, over the entirety of the area of the outer circumference of the support shaft 32. No matter which direction pressure is applied to the massage ball 30, the pressure may be cushioned by deformation of the elastic body 37. Therefore, unlike a spring mechanism unable to cushion pressure in a predetermined direction, the massage ball 30 in the illustrated embodiment of the disclosure may adjust the pressure applied to the human body regardless of the body shape of the person to be treated or the inclination of the backrest 13 during the treatment.

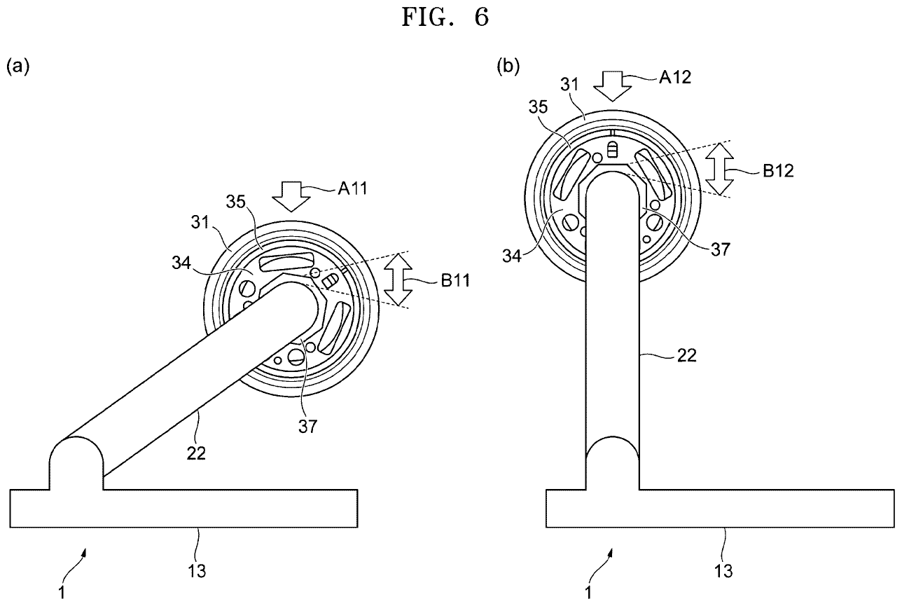

FIG. 6A is a view for explaining an embodiment of a first operation of the elastic body 37 applied to the massage ball 30, according to the disclosure. (a) of FIG. 6 shows the first action of the elastic body 37 when the arm 22 forms an acute angle with respect to the backrest 13 of the massaging machine 1. Referring to (a) of FIG. 6, even when pressure is applied to the massage ball 30 as shown by arrow A11 during a treatment, the elastic body 37 may be deformed as indicated by arrow B11 to buffer the pressure. (b) of FIG. 6 shows the first action of the elastic body 37 when the arm 22 is perpendicular to the backrest 13 of the massaging machine 1. Referring to (b) of FIG. 6, even when pressure is applied to the massage ball 30 as shown by arrow A12 during a treatment, the elastic body 37 may be deformed as indicated by arrow B12 to buffer the pressure.

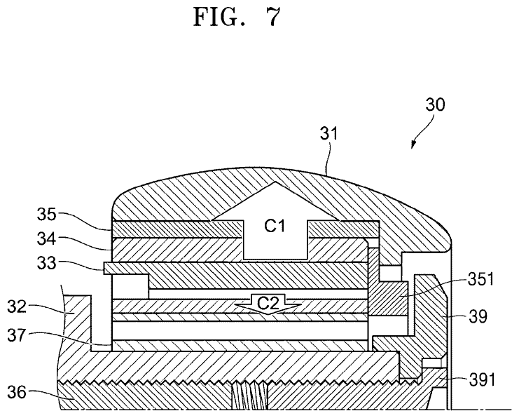

FIG. 7 is a view for explaining an embodiment of a second operation of the elastic body 37 applied to the massage ball 30, according to the disclosure. FIG. 7 shows an upper half of the cross-sectional view of FIG. 3. Referring to FIG. 7, arrows C1 and C2 represent first heat energy transmitted from the heater 33 to the surface part 31 and second heat energy transmitted from the heater 33 to the support shaft 32, respectively. A difference between the amount of the first heat energy and the amount of second heat energy is visually expressed by respective thicknesses of the arrows C1 and C2. In the massage ball 30 according to the disclosure, because the elastic body 37 thermally insulates between the heater 33 and the support shaft 32, heat energy transmitted from the heater 33 to the support shaft 32 is smaller than heat energy transmitted from the heater 33 to the support shaft 32.

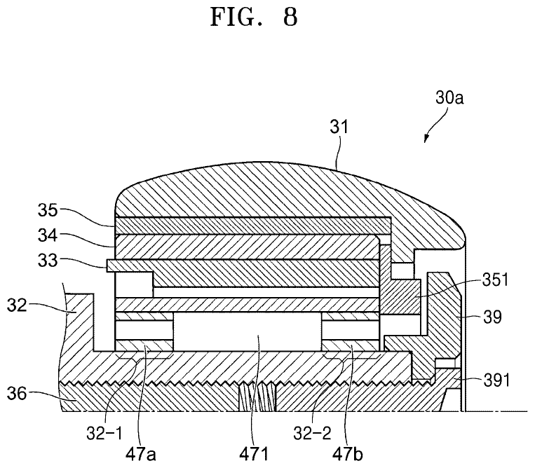

FIG. 8 is a schematic cross-sectional view of an embodiment of a massage ball 30a according to the disclosure. FIG. 8 corresponds to the upper half of the cross-sectional view of FIG. 3. The massage ball 30a in the illustrated embodiment of the disclosure is different from the massage ball 30 of FIGS. 2 through 7 in terms of the shape and arrangement of an elastic body. Hereinafter, components performing the same function will be indicated by the same reference numeral, and repeated descriptions thereof will be omitted. Differences therebetween will now be focused on and described.

Referring to FIG. 8, the massage ball 30a in the illustrated embodiment of the disclosure includes a first elastic body 47a and a second elastic body 47b. The first elastic body 47a and the second elastic body 47b are disposed apart from each other in the axial direction of the support shaft 32 with a hollow area 471 interposed therebetween. The first elastic body 47a and the second elastic body 47b may be disposed adjacent to opposite ends of the support shaft 32 in the axial direction. In an embodiment, the first elastic body 47a covers a portion adjacent to one end of the support shaft 32, and the second elastic body 47b covers a portion adjacent to an opposite end of the support shaft 32, for example. The hollow area 471 is interposed between the first elastic body 47a and the second elastic body 47b. According to this structure, thermal insulation between the heat transfer part 34 and the support shaft 32 may be further improved. In FIG. 8, the first elastic body 47a is provided on one end of the support shaft 32, and the second elastic body 47b is provided on an opposite end of the support shaft 32. However, the disclosure is not limited thereto. The outer circumferential area of the support shaft 32 may include two areas spaced apart from each other in the axial direction, e.g., a first area (also referred to as first axis area) 32-1 and a second area (also referred as second axis area) 32-2. The first elastic body 47a may be provided to cover a predetermined area (first axis area 32-1) near the one end of the support shaft 32, and the second elastic body 47b may be provided to cover a predetermined area (second axis area 32-2) near an opposite end of the support shaft 32. A hollow area may be provided not only between the first elastic body 47a and the second elastic body 47b, but also, near one end of the first elastic body 47a, e.g., an end opposite to the hollow area 471 (in FIG. 8, near the left end of the first elastic body 47a) and/or near an opposite end of the second elastic body 47b, e.g., an end opposite to the hollow area 471 (in FIG. 8, near the right end of the second elastic body 47b). In other words, an arrangement of hollow area, first elastic body 47a, hollow area 471, second elastic body 47b, and hollow area may be established.

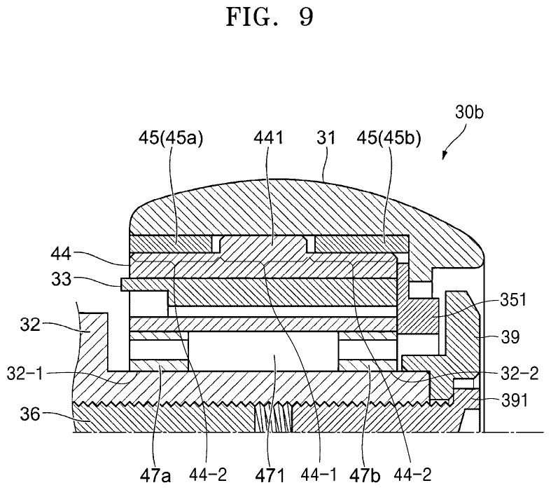

FIG. 9 is a schematic cross-sectional view of an embodiment of a massage ball 30b according to the disclosure. FIG. 9 corresponds to the upper half of the cross-sectional view shown in FIG. 3. Compared to the massage ball 30a shown in FIG. 8, the massage ball 30b of FIG. 9 uses a heat transfer part 44 and a sliding part 45 instead of the heat transfer part 34 and the sliding part 35. Hereinafter, components performing the same function will be indicated by the same reference numeral, and repeated descriptions thereof will be omitted. Differences therebetween will now be focused on and described.

Referring to FIG. 9, the heat transfer part 44 includes a convex shape portion 441. The convex shape portion 441 protrudes outward from an outer circumference of the heat transfer part 44. The sliding part 45 has a less axial length than that of the surface part 31. In the illustrated embodiment of the disclosure, the sliding part 45 includes a first sliding portion 45a and a second sliding portion 45b spaced apart from each other in the axial direction. The convex shape portion 441 of the heat transfer part 44 is inserted between the first sliding portion 45a and the second sliding portion 45b and protrudes convexly toward the surface part 31. In other words, the outer circumferential area of the heat transfer part 44 may include a first area 44-1 provided with the convex shape portion 441 and a second area 44-2 not provided with the convex shape portion 441. The first area 44-1 and the second area 44-2 are arranged in the axial direction. The sliding part 45 may be provided on the second area 44-2 of the outer circumferential area of the heat transfer part 44. In the illustrated embodiment of the disclosure, the first area 44-1 is provided between a pair of second areas 44-2, and the first and second sliding portions 45a and 45b are provided on the pair of second areas 44-2, respectively.

According to this configuration, even when the sliding part 45 includes or consists of a material with relatively low thermal conductivity, because the convex shape portion 441 of the heat transfer part 44 with relatively high thermal conductivity is disposed close to the surface part 31, heat from the heater 33 may be effectively transferred to the surface part 31.

In FIG. 9, the first sliding part 45a is provided on one end of the heat transfer part 44, and the second sliding portion 45b is provided on an opposite end of the heat transfer part 44. However, the disclosure is not limited thereto. The sliding part 45 may be provided on a portion of the outer circumferential area of the heat transfer part 44 in the axial direction. In this case, the convex shape portion 441 of the heat transfer part 44 may be provided in an area of the outer circumferential area of the heat transfer part 44 where the sliding part 45 is not provided.

Although not shown in the drawings, the heat transfer part 44 and the sliding part 45 shown in FIG. 9 are also applicable to the massage ball 30 shown in FIGS. 2 through 7.

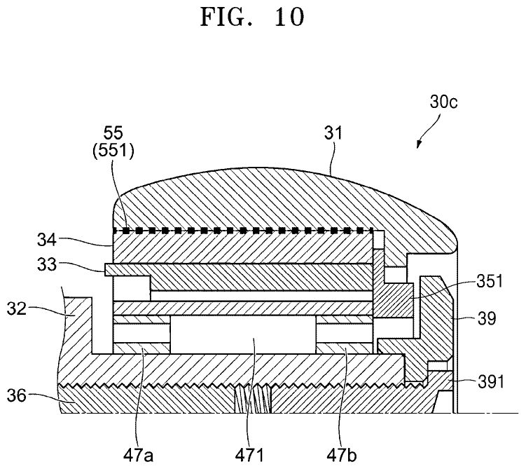

FIG. 10 is a schematic cross-sectional view of an embodiment of a massage ball 30c according to the disclosure. FIG. 10 corresponds to the upper half of the cross-sectional view shown in FIG. 3. The massage ball 30c shown in FIG. 10 is different from the massage ball 30a shown in FIG. 8 in that the massage ball 30c employs a sliding part 55 including a thermal spray coating 551. Hereinafter, components performing the same function will be indicated by the same reference numeral, and repeated descriptions thereof will be omitted. Differences therebetween will now be focused on and described.

Referring to FIG. 10, the sliding part 55 includes the thermal spray coating 551. The thermal spray coating 551 is interposed between the surface part 31 and the heat transfer part 34. The thermal spray coating 551 may be formed on at least one of an inner circumferential surface of the surface part 31 or an outer circumferential surface of the heat transfer part 34. The thermal spray coating 551 functions as the sliding part 55 that allows the surface part 31 to rotate relative to the heat transfer part 34.

Although not shown in the drawings, the sliding part 35 of the massage ball 30 shown in FIGS. 2 through 7 and the sliding part 45 shown in FIG. 9 may be replaced with the sliding part 55 including the thermal spray coating 551 shown in FIG. 9.

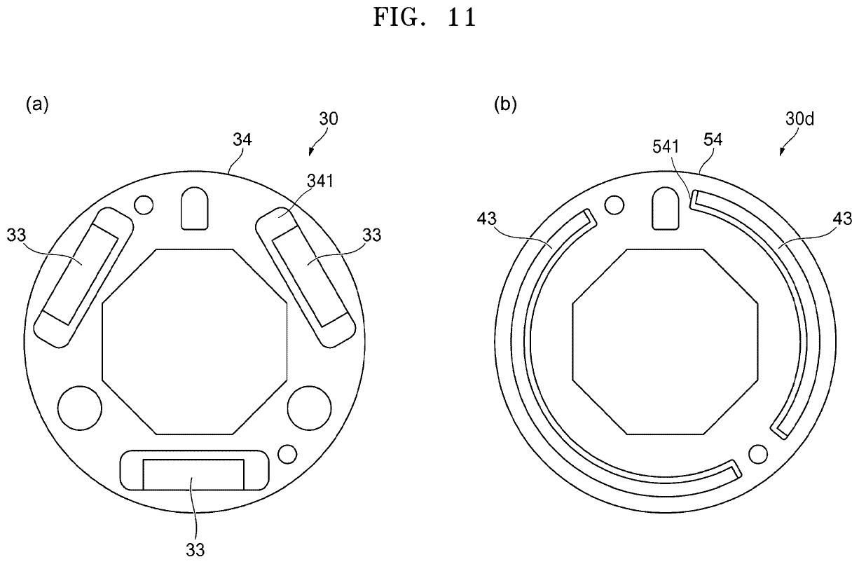

FIG. 11 is a schematic cross-sectional view of an embodiment of a massage ball 30d according to the disclosure. (a) of FIG. 11 shows a cross-section perpendicular to the support shaft 32 of the massage ball 30 shown in FIG. 2, and (b) of FIG. 11 shows a cross section perpendicular to the support shaft 32 of the massage ball 30d according to the disclosure. The shape of a heater 43 of the massage ball 30d in the illustrated embodiment of the disclosure is different from that of the heater 33 of the massage ball 30. Hereinafter, components performing the same function will be indicated by the same reference numeral, and repeated descriptions thereof will be omitted. Differences therebetween will now be focused on and described.

Referring to (a) of FIG. 11, in the case of the massage ball 30, the inflexible quadrangular, e.g., rectangular, heater 33 is disposed while not being curved within the heat transfer part 34. An accommodating part 341 for accommodating the heater 33 is provided in the heat transfer part 34. The accommodating part 341 may have the same cross-sectional shape as that of the heater 33, e.g., a quadrangular shape, e.g., rectangular shape. In (a) of FIG. 11, three accommodating parts 341 and three heaters 33 disposed therein are shown. However, the disclosure is not limited thereto. In the case of the massage ball 30d in the illustrated embodiment of the disclosure, as shown in (b) of FIG. 11, the heater 43 in a flexible film shape is disposed in a curved arc shape within the heat transfer part 54. In an embodiment, the heat transfer part 54 includes an accommodating part (also referred to as an arc-shaped accommodating part) 541, for example. The heater 43 in the film shape is curved into an arc shape and is accommodated in the accommodating part 541. According to this configuration, a contact area between the heat transfer part 54 and the heater 43 increases, leading to an increase in the efficiency of heat transfer from the heater 43 to the surface part 31 (refer to FIGS. 2 to 10). Thus, the number of heaters 43 may be reduced, and the massage ball 30d may be miniaturized. The heater 43 and the heat transfer part 44 shown in (b) of FIG. 11 may also be applied to the massage balls 30a, 30b, and 30c shown in FIGS. 8, 9, and 10, respectively.

FIG. 12 is a cross-sectional view of an embodiment of a massage ball 30e according to the disclosure. (a) of FIG. 12 is a cross-sectional view taken along a plane including a center axis of the support shaft 32 of the massage ball 30 shown in FIGS. 2 through 7, and (b) of FIG. 12 is a cross-sectional view taken along a plane including a center axis of a support shaft 52 of the massage ball 30e according to the disclosure. The massage ball 30e in the illustrated embodiment of the disclosure is different from the massage ball 30 shown in FIG. 2 in terms of its coupling structure with the arm 22. Hereinafter, components performing the same function will be indicated by the same reference numeral, and repeated descriptions thereof will be omitted. Differences therebetween will now be focused on and described.

Referring to (a) of FIG. 12, the massage ball 30 is fixed to the arm 22 by fastening one end of the support shaft 32 to an end 221 of the arm 22 by the fastening screw 36. The elastic body 37 is disposed over the entirety of the outer circumference of the support shaft 32. Referring to (b) of FIG. 12, the massage ball 30e in the illustrated embodiment of the disclosure is fixed to the arm 22 by fixing opposite ends of the support shaft 52, namely, a first end 52-1 and a second end 52-2, to a pair of ends 222 of the arm 22, namely, first and second ends 222a and 222b, by a pair of fastening screws 56, namely, first and second fastening screws 56a and 56b. An elastic body 57, that is, a first elastic body 57a and a second elastic body 578b, may be disposed between the first end 222a of the arm 22 and the first end 52-1 of the support shaft 52 and between the second end 222b of the arm 22 and the second end 52-2 of the support shaft 52, respectively. In an embodiment, the first elastic body 57a may be disposed within the first fastening screw 56a interposed between the first end 222a of the arm 22 and the support shaft 52, and the second elastic body 57b may be disposed within the second fastening screw 56b interposed between the second end 222b of the arm 22 and the support shaft 52, for example. An arm guide part 223 that comes in sliding contact with the first end guide part 38 and the second end guide part 39 to regulate the massage ball 30e to move only in the radial direction is disposed on the second end 222b of the arm 22. That is, the arm guide part 223 regulates respective movements of the first end guide part 38 and the second end guide part 39 in the axial direction. In (b) of FIG. 12, the first end guide part 38 is not shown. According to this configuration, even when the support shaft 52 is miniaturized or resinified and its strength is weak, the support shaft 52 may withstand the pressure applied to the massage ball 30e. The elastic body 57 is disposed in a heat transfer path HTP ranging from the heat transfer part 34 to the arm 22 via the support shaft 52. Therefore, the elastic body 57 thermally insulates between the support shaft 52 and the arm 22 to suppress transfer of heat energy. Accordingly, heat from the heater 33 may be transferred to the surface part 31 efficiently with less energy.

In the massage ball 30e shown in (b) of FIG. 12, the elastic body 37 is not disposed on the outer circumference of the support shaft 52, but the disclosure is not limited thereto. Although not shown in the drawing, the massage ball 30e may further include the elastic body 37 disposed on the outer circumference of the support shaft 52. In this case, the elastic body 37 and the elastic body 57 are disposed in the heat transfer path HTP from the heat transfer part 34 to the arm 22. Accordingly, heat from the heater 33 may be transferred to the surface part 31 efficiently with less energy. A coupling structure between the massage ball 30e and the arm 22 shown in FIG. 12 may also be applied to the massage balls 30a, 30b, 30c, and 30d shown in FIGS. 8 through 11, respectively.

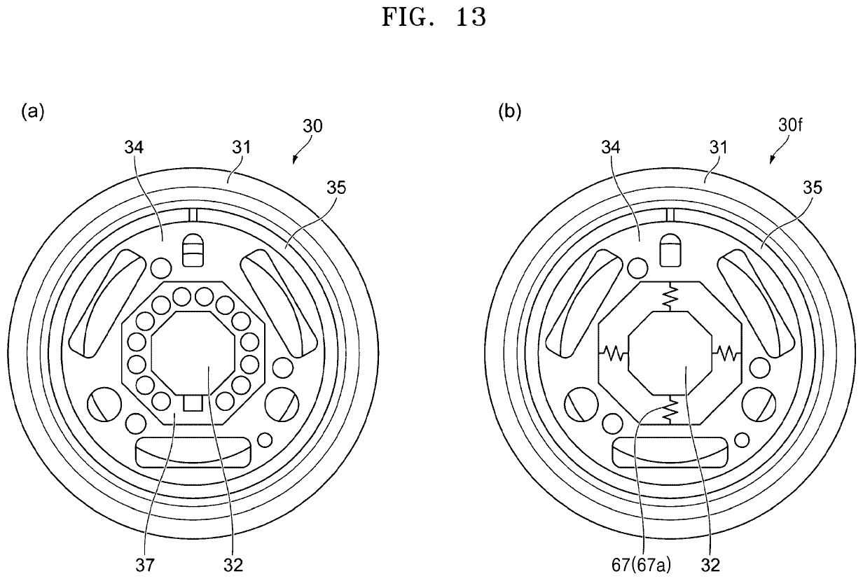

FIG. 13 is a cross-sectional view of an embodiment of a massage ball 30f according to the disclosure. (a) of FIG. 13 shows a cross-section perpendicular to the support shaft 32 of the massage ball 30 shown in FIG. 2, and (b) of FIG. 13 shows a cross section perpendicular to the support shaft 32 of the massage ball 30f according to the disclosure. The massage ball 30f in the illustrated embodiment of the disclosure is different from the above-described embodiments of a massage ball in that the massage ball 30f employs a spring as an elastic body 67. Hereinafter, components performing the same function will be indicated by the same reference numeral, and repeated descriptions thereof will be omitted. Differences therebetween will now be focused on and described.

Referring to (a) of FIG. 13, in the massage ball 30, the elastic body 37 including or consisting of a material that is elastically deformable due to rubber properties is disposed between the heat transfer part 34 and the support shaft 32. Referring to (b) of FIG. 13, the massage ball 30f in the illustrated embodiment of the disclosure employs a plurality of metal springs 67a as the elastic body 67. The plurality of metal springs 67a is arranged between the heat transfer part 34 and the support shaft 32. According to this configuration, a buffering function equivalent to that of the elastic body 37 having rubber properties may be realized even with the metal springs 67a including relatively small contact areas and cross-sectional areas. The metal springs 67a of the massage ball 30f shown in FIG. 13 may also be applied to the massage balls 30a, 30b, 30c, 30d, and 30e shown in FIGS. 8 through 12, respectively.

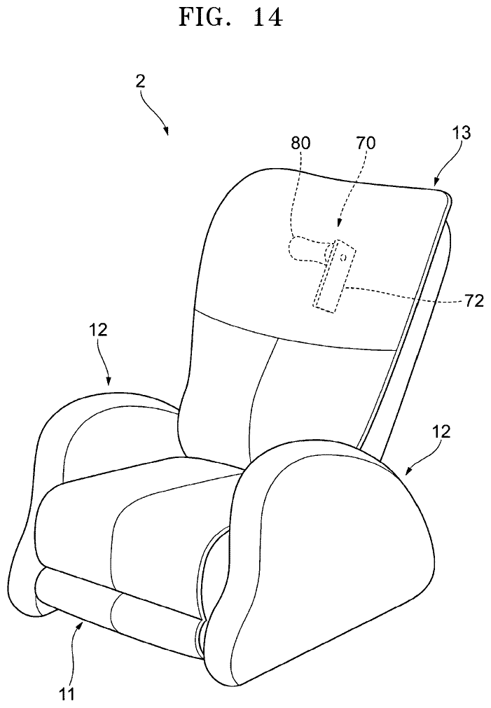

FIG. 14 is a schematic perspective view of an embodiment of the exterior of a massage machine 2 according to the disclosure. Referring to FIG. 14, the massage machine 2 includes a seat part 11, a pair of support frames 12 supporting the seat part 11, and a backrest 13 supported by the pair of support frames 12 while being disposed on the rear side of the seat part 11. The massage machine 2 includes a massage mechanism 70 capable of massaging an affected area of a person to be treated. As described above, a front-rear direction, a left-right direction (width direction), and an up-down direction are directions seen from the perspective of the person to be treated when the person sits on the seat part 11. Because the seat part 11, the support frame 12, and the backrest 13 are the same as those of the massage machine 1 in FIG. 1, overlapping descriptions thereof are omitted.

The massage mechanism 70 is provided inside the backrest 13 to massage the neck of the person to be treated. The massage mechanism 70 includes one massage ball 80 for massaging the neck and one arm 72 for operating the massage ball 80. In other words, the massage mechanism 70 may realize a massage function with minimized cost by narrowing the function to parasympathetic nerve activation of the neck by excluding massage functions other than for the neck.

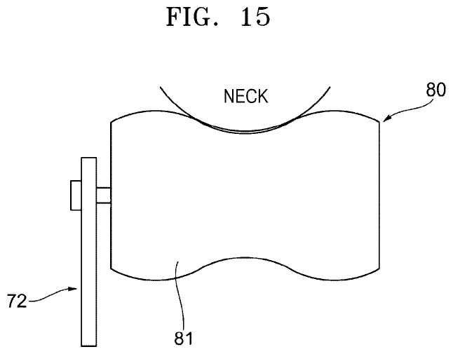

FIG. 15 is a schematic plan view of an embodiment of the massage ball 80 applied to the massage machine 2 shown in FIG. 14. FIG. 15 shows that the upper portion of the drawing is a front side of the massaging machine 2.

Referring to FIG. 15, the massage ball 80 includes a surface part 81. The shape of the surface part 81 of the massage ball 80 is not limited to a substantially circular arc shape that is the same as that of the surface part 31 shown in FIGS. 2 through 4. In an embodiment, the surface part 81 may be shaped like a gourd with a center portion being concave compared to opposite ends, as shown in FIG. 15, for example. According to this configuration, the massage ball 80 may effectively massage the suboccipital muscles, the multifidus muscles, etc., on the back of the neck, which have an effect on the activation of parasympathetic nerves.

The structure of the massage ball 80 may be the same as that of the massage ball 30 shown in FIGS. 2 through 4. In an embodiment, the structure for adjusting the pressure when the massage ball 30 touches the human body by heating the surface part 31 applied to the massage machine 1 may also be applied to the massage ball 80 of the massage machine 2, for example.

As described above, by disposing a heater inside a massage ball and forming the entirety of the surface of the massage ball with a material having relatively high thermal conductivity, the temperature of the surface of the massage ball may be uniformized. In addition, according to a structure in which an elastic body is disposed inside the massage ball to form cushioning and thermal insulation, and/or a structure in which an elastic body is disposed between the massage ball and an arm to form cushioning and thermal insulation, the pressure when the hard massage ball touches the human body may be adjusted, leading to an improvement in the energy efficiency when the surface of the massage ball is heated.

A massage machine in an embodiment of the disclosure includes a massage ball and an arm to which the massage ball is fixed. The massage ball includes a surface part; a support shaft fixed to the arm; a heater for heating the surface part; a heat transfer part which is disposed between the surface part and the support shaft and transfers heat from the heater to the surface part; a sliding part that come into sliding contact with the surface part and rotatably support the surface part with respect to the heat transfer part; and an elastic body disposed on a heat transfer path between the heat transfer part and the arm.

In an embodiment of the disclosure, the elastic body may be disposed between the heat transfer part and the support shaft.

In an embodiment of the disclosure, the elastic body may cover an entirety of an outer circumference of the support shaft.

In an embodiment of the disclosure, an outer circumferential area of the support shaft may include a first area and a second area spaced apart from each other in an axial direction. The elastic body may include a first elastic body and a second elastic body covering the first area and the second area, respectively.

In an embodiment of the disclosure, the elastic body may include a rubber elastic material.

In an embodiment of the disclosure, the elastic body may include a plurality of metal springs.

In an embodiment of the disclosure, the surface part, the sliding part, the heat transfer part, and the elastic body may be disposed concentrically with a support axis of the support shaft as a center.

In an embodiment of the disclosure, the support shaft may include a first end fixed to a first end of the arm, and a second end fixed to a second end of the arm. The elastic body may include a first elastic body disposed between the first end of the support shaft and the first end of the arm, and a second elastic body disposed between the second end of the support shaft and the second end of the arm.

In an embodiment of the disclosure, the sliding part may be disposed on the entirety of the outer circumferential area of the heat transfer part.

In an embodiment of the disclosure, the sliding part may include a first sliding portion and a second sliding portion spaced apart from each other in an axial direction. The heat transfer part may include a convex shape portion protruding toward the surface part and disposed between the first sliding portion and the second sliding portion.

In an embodiment of the disclosure, the sliding part includes a sliding portion, and the sliding portion may include a thermal spray coating formed on at least one of an inner circumferential surface of the surface part or an outer circumferential surface of the heat transfer part.

In an embodiment of the disclosure, the heater in a non-curved state may be disposed within the heat transfer part.

In an embodiment of the disclosure, the heater may be in a shape of a flexible film.

In an embodiment of the disclosure, the heat transfer part may include an accommodating part having an arc shape, and the heater in a state of being curved in an arc shape may be disposed in the accommodating part.

In an embodiment of the disclosure, the massage ball may have a gourd shape in which a center portion is concave compared to opposite ends.

By the above-described embodiments of the disclosure, a surface part of a massage ball may be heated to a uniform temperature, and the pressure when the massage ball touches the human body may be adjusted regardless of the direction of the pressure acting on the massage ball. In addition, transfer of heat energy to a support shaft and an arm may be suppressed.

The technical effects to be achieved in this document are not limited to the above-mentioned technical effects, and other technical effects not mentioned will be clearly understood by a person skilled in the art to which the disclosure pertains from the following description.

As described above, although a massaging machine according to the disclosure has been described using limited embodiments and drawings, the disclosure is not limited to the above embodiments, and various modifications are possible without departing from the spirit thereof.

1. A massage machine comprising:
an arm; and
a massage ball fixed to the arm, the massage ball comprising:
a surface part;
a support shaft fixed to the arm;
a heater for heating the surface part;
a heat transfer part which is disposed between the surface part and the support shaft and transfers heat from the heater to the surface part;
a sliding part that comes into sliding contact with the surface part and rotatably supports the surface part with respect to the heat transfer part; and
an elastic body disposed on a heat transfer path between the heat transfer part and the arm.

2. The massage machine of claim 1, wherein the elastic body is disposed between the heat transfer part and the support shaft.

3. The massage machine of claim 1, wherein the elastic body covers an entirety of an outer circumference of the support shaft.

4. The massage machine of claim 1, wherein an outer circumferential area of the support shaft includes a first area and a second area spaced apart from each other in an axial direction, and
the elastic body includes a first elastic body and a second elastic body covering the first area and the second area, respectively.

5. The massage machine of claim 1, wherein the elastic body includes a rubber elastic material.

6. The massage machine of claim 1, wherein the elastic body includes a plurality of metal springs.

7. The massage machine of claim 1, wherein the surface part, the sliding part, the heat transfer part, and the elastic body are disposed concentrically with a support axis of the support shaft as a center.

8. The massage machine of claim 1, wherein the support shaft includes a first end fixed to a first end of the arm, and a second end fixed to a second end of the arm, and
the elastic body includes a first elastic body disposed between the first end of the support shaft and the first end of the arm, and a second elastic body disposed between the second end of the support shaft and the second end of the arm.

9. The massage machine of claim 1, wherein the sliding part is disposed on an entirety of an outer circumferential area of the heat transfer part.

10. The massage machine of claim 1, wherein the sliding part includes a first sliding portion and a second sliding portion spaced apart from each other in an axial direction, and
the heat transfer part includes a convex shape portion protruding toward the surface part) and disposed between the first sliding portion and the second sliding portion.

11. The massage machine of claim 1, wherein
the sliding part includes a thermal spray coating formed on at least one of an inner circumferential surface of the surface part or an outer circumferential surface of the heat transfer part.

12. The massage machine of claim 1, wherein the heater in a non-curved state is disposed in the heat transfer part.

13. The massage machine of claim 1, wherein the heater is in a form of a flexible film.

14. The massage machine of claim 13, wherein the heat transfer part includes an accommodating part having an arc shape, and
the heater in a state of having an arc shaped curve is disposed in the accommodating part.

15. The massage machine of claim 1, wherein the massage ball has a gourd shape in which a center portion of the massage ball is concave compared to opposite ends of the massage ball.

16. A massage machine comprising:
a massage ball comprising:
a surface part;
a support shaft;
a heater for heating the surface part;
a heat transfer part which is disposed between the surface part and the support shaft and transfers heat from the heater to the surface part;
a sliding part that comes into sliding contact with the surface part and rotatably supports the surface part with respect to the heat transfer part; and
an elastic body disposed on the heat transfer part.

17. The massage machine of claim 16, wherein the elastic body is disposed between the heat transfer part and the support shaft.

18. The massage machine of claim 16, wherein the elastic body covers an entirety of an outer circumference of the support shaft.

19. The massage machine of claim 16, wherein an outer circumferential area of the support shaft includes a first area and a second area spaced apart from each other in an axial direction, and
the elastic body includes a first elastic body and a second elastic body covering the first area and the second area, respectively.

20. The massage machine of claim 16, wherein the elastic body includes a rubber elastic material.
